(19) United States
(12) Patent Application Publication
(10) Pub. No.: US 2009/0006979 A1
(43) Pub. Date: Jan. 1, 2009

(54) TEXT EXCHANGE FACILITY FOR JOINING MULTIPLE TEXT EXCHANGE COMMUNICATIONS INTO A SINGLE TOPIC BASED COMMUNICATION

(75) Inventors: SEAN CALLANAN, CHURCHTOWN (IE); AL CHAKRA, APEX, NC (US); HUGH SMYTH, CLONTARF (IE); SMRITI TALWAR, CLONSILLA (IE)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/769,483

(22) Filed: Jun. 27, 2007

(51) Int. Cl. G06F 3/00

(52) U.S. Cl. 715/751

(57) ABSTRACT

The present invention discloses a text exchange facility that permits a user to combine multiple pre-existing text exchange interfaces into a single interface. When previous text exchange interfaces are joined, different tabs can be presented in a joined interface. A one-to-one correspondence can exist between tabs in the joined interface and active real-time text exchange sessions. Joining interfaces can have no effect on the underlying text exchange sessions or upon communications/activities experienced by communicators with whom the user exchanges textual messages. Joined interfaces can be identified by a user specified topic or name. In one embodiment, history and/or records concerning text exchange contents can be maintained on a topic-by-topic manner.

### BACKGROUND

1. Field of the Invention

The present invention relates to text exchange technologies, and more particularly, a text exchange facility for joining multiple text exchange communications into a single topic based communication.

2. Description of the Related Art

A text exchange communication refers to any real-time, interactive, text communication mechanism, such as chatting, instant messaging, text messaging, and the like. Text exchanges provide an efficient communication mechanism for exchanging information between parties. One advantage afforded by text exchange communications is that a text-exchange communicator can actively participate in multiple concurrent real-time communication sessions, each session involving a different set of one or more other communicators. It is a common practice for a project manager, customer service representative, a mediator, and other coordinators to instantiate multiple text exchange interfaces at a time. Simultaneously utilizing these multiple interfaces can be confusing and incurs a risk that a user will become confused and inadvertently convey information to an unintended recipient. Further, archiving details of a series of communications conducted over different text-exchange interfaces can be difficult.

To illustrate by example, a senior engineer of a large company, fictitiously named Joe Bloggs, can be responsible for assisting teams of deployed engineers, system managers, technicians, designers, and the like. On a typical day, Joe can respond to hundreds of inquiries. At any one time, Joe can have eight to ten text exchange interfaces active. Often, a single situation results in Joe coordinating with multiple people, each having a corresponding text exchange interface. Use of these multiple interfaces can be confusing, can result in mistakes, and can make archiving or follow-up actions difficult.

### SUMMARY OF THE INVENTION

The present invention discloses a text exchange facility that permits a user to combine multiple pre-existing text exchange interfaces into a single interface. When previous text-exchange interfaces are joined, different tabs can be presented in a joined or combined interface. A one-to-one correspondence can exist between tabs in the joined interface and active real-time text exchange sessions. Joining interfaces can have no effect on the underlying text exchange sessions or upon communications/activities experienced by communicators with whom the user exchanges textual messages. Joined interfaces can be identified by a user specified topic or name. In one embodiment, history and/or records concerning text exchange contents can be maintained on a topic-by-topic manner.

The present invention can be implemented in accordance with numerous aspects consistent with the material presented herein. For example, one aspect of the present invention can include a method for combining text exchange interfaces for different sessions into a single interface. The method can include a step of detecting a join interface event associated with a plurality of different interfaces. Each of the different interfaces can be associated with at least one text exchange session. A combined interface can be created through which a user is able to participate in each of the text exchange sessions originally associated with the different interfaces. The combined interface can be presented in a graphical user interface. The different interfaces can be automatically closed when the combined interface is presented.

Another aspect of the present invention can include a text exchange application that includes a joining engine. The joining engine can create a single combined text exchange interface from a plurality of user selected interfaces that are each associated with a text exchange session. The combined text exchange interface is one that enables a user to participate in each of the text exchange sessions associated with the plurality of user selected interfaces.

Still another aspect of the present invention can include a combined text exchange interface. The combined text interface includes more than one user selectable graphical user interface items which can be session specific tabs. Each of the tabs can be associated with a related communication session. Each session can originally correspond to a session specific interface. These session interfaces can be combined into the combined interface responsive to a user input. The text exchange interface can include a dialog region displaying text exchanged during the associated text exchange session and an outgoing region in which a user is able to type new messages that are to be conveyed to remote communicators involved in the associated text exchange session.

It should be noted that various aspects of the invention can he implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

It should also be noted that the methods detailed herein can also be methods performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a text exchange, system that includes at least one text exchange application having a topic based joining facility in accordance with an embodiment of the inventive arrangements disclosed herein.

FIG. 2 shows a sequence of interfaces in which a text exchange application joins multiple discrete interfaces into a single one in accordance with an embodiment of the inventive arrangements disclosed herein.

FIG. 3 shows a computing interface of a joined text exchange interface in accordance with an embodiment of the inventive arrangements disclosed herein.

FIG. 4 shows an interface for configuring options of a text exchange interface in accordance with an embodiment of the inventive arrangements disclosed herein.

### DETAILED DESCRIPTION OF THE INVENTION

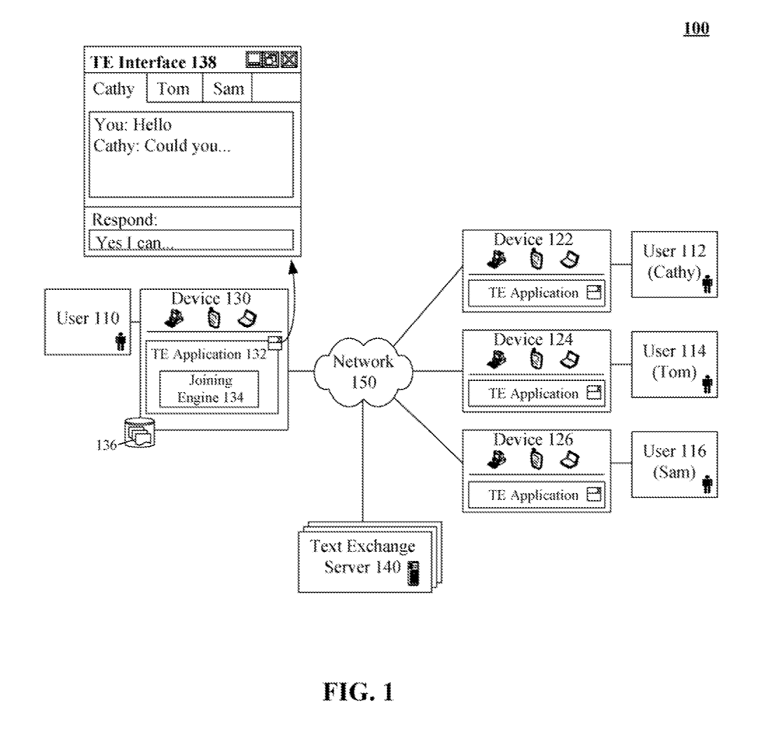

FIG. 1 is a schematic diagram illustrating a text exchange system 100 that includes at least one text exchange application 132 having a topic based joining facility in accordance with an embodiment of the inventive arrangements disclosed herein. As used herein, text exchange refers to any real-time, interactive, text based communication mechanism, such as chatting, instant messaging, text messaging, and the like. Text exchange communications for purposes of system 100 can include content in addition to text, such as audio, video, pictures, Web links, file exchanges, and the like. Hence, any type of communication, which includes an exchange of text between two or more users 110-116, can be considered a text exchange communication.

In system 100, the joining facility can be used to join multiple, previously distinct text exchange interfaces into a singe interface 138 responsive to a user selection. The user 110 can also establish a context or name for the joined interface 138. For example, if Cathy, Tom, and Sam from interface 138 are all engineers working on a common project, the context for interface 138 can be “Engineer˜Project ABC.” The joined interface 138 permits user 110 to reduce screen clutter and typographical errors, which are common when multiple text exchange interfaces are presented within a single desktop. Further, context specific archives 136 can be stored for all communications occurring within interface 138 which helps user 110 organize communications for later reference. Appreciably, when a communication context spans multiple interfaces (not shown), multiple archives 136 can result which can be very difficult to later reconstruct to create a cohesive communication.

As shown in FIG. 1, users 110-116 can each utilize a device 122-126, 130 equipped with a text exchange application to communicate with each other via network 150. Text exchange server 140 can optionally facilitate communications, unless the communications are peer-to-peer exchanges. Initially, user 110 can be presented with separate text exchange interfaces (not shown) for user 112 (Cathy), user 114 (Tom), and user 116 (Sam). A user 110 interaction can trigger the capabilities of a joining engine 134 to create text exchange interface 138 which represents a joining of three previously distinct interfaces. In one embodiment, the joining does not affect communications with any of the users 112-116 and these users 112-116 can remain unaware of an occurrence of a consolidation of the communication interfaces by user 110. Previous communications presented within the previously un-joined interfaces can optionally be moved into the new joined interface 138.

In one optional implementation of system 100, user 110 can be provided an option to conference one or more of the previously distinct communicators together. For example, user 110 can be permitted to join Cathy (user 112) and Tom (user 114) into a single unified communication session. The tabs of interface 138 would then change to reflect this conferencing. That is, instead of user 110 conducting three distinct text exchange sessions with users 112, 114, and 116 respectively, the user 110 would be conducting two text exchange sessions—a first involving users 110-114; and, a second involving user 110 and user 116.

The devices 122-126, 130 can each be a communication device configured to engage in text exchange communications with a text exchange communication recipient. Each device 122-126, 130 can be implemented as any of a variety of computing devices including, but not limited to, a personal computer, a notebook, a kiosk, a personal data assistant (PDA), a mobile phone, a media player, a communication station, and the like. Each device 122-126, 130 can include hardware/software/firmware representing a text exchange application. In one embodiment, different devices 122-126, 130 can communicate with each other using different text exchange protocols, which a network intermediary (server 140) transforms to enable compatible exchanges. For example, device 124 can utilize a text messaging protocol to exchange text with device 126, which utilizes an Instant Messaging protocol.

Text exchange server 140 can be used to receive a textual message from device 122, or a similar device, and deliver the textual message to a text exchange communication recipient. The text exchange server 140 can be a text messaging server, a chat server, an instant messaging server, and the like. The server 140 can optionally include transcoding and conversion capabilities. In one embodiment, the server 140 can include speech processing capabilities which permit text exchanges to be dynamically converted to and from speech, so that a different communicator (not shown) using a voice user interface (VUI) can communicate in real time using a speech modality with any of the devices 122-126, 130, which use a text exchange modality.

The joining engine 134 can be used to join multiple text exchange communications into a single topic based communication. In one embodiment, joining engine 134 can be code incorporated within application 132. The joining engine 134 can also be implemented as a software plug-in, which enhances capabilities of the text exchange application 132.

Network 150 can include any hardware/software/and firmware necessary to convey digital content encoded within carrier waves. Content can be contained within analog or digital signals and conveyed through data or voice channels and can be conveyed over a personal area network (PAN) or a wide area network (WAN). The network 150 can include local components and data pathways necessary for communications to be exchanged among computing device components and between integrated device components and peripheral devices. The network 150 can also include network equipment, such as routers, data lines, hubs, and intermediary servers which together form a packet-based network, such as the Internet or an intranet. The network 150 can further include circuit-based communication components and mobile communication components, such as telephony switches, modems, cellular communication towers, and the like. The network 150 can include line based and/or wireless communication pathways.

The archives 136 can be stored in a data store. This data store can be physically implemented within any type of hardware including, but not limited to, a magnetic disk, an optical disk, a semiconductor memory, a digitally encoded plastic memory, a holographic memory, or any other recording medium. The data store can be a stand-alone storage unit as well as a storage unit formed from a plurality of physical devices, which may be remotely located from one another. Additionally, information can be stored within each data store in a variety of manners. For example, information (e.g., archives 136) can be stored within a database structure or can be stored within one or more files of a file storage system, where each file may or may not be indexed for information searching purposes.

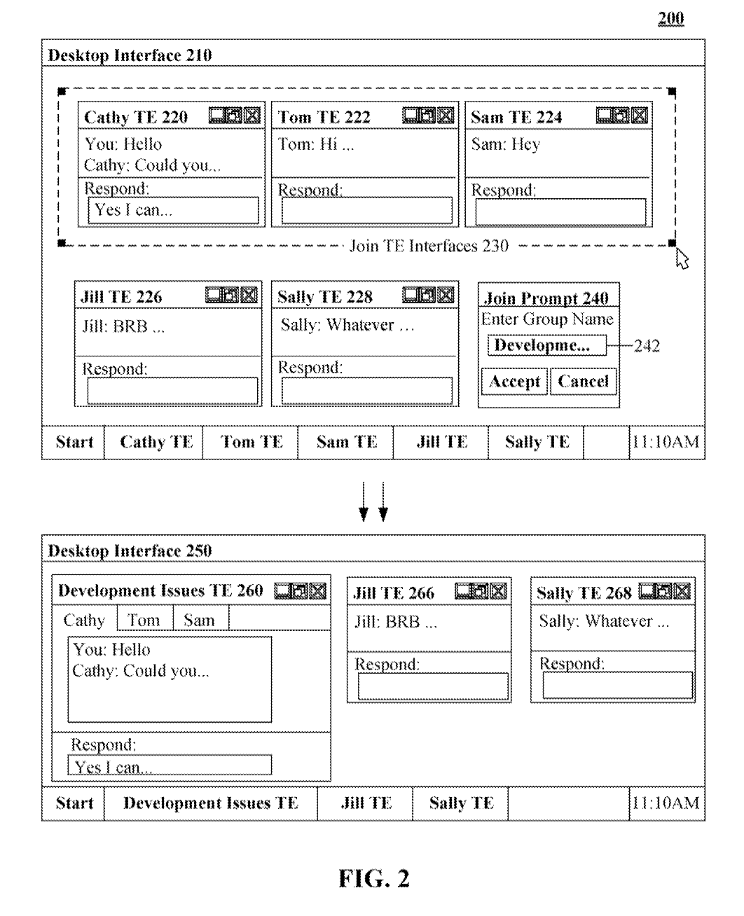

FIG. 2 shows a diagram 200 of a sequence of interfaces 220-224 in which a text exchange application joins multiple discrete interfaces into a single one 260 in accordance with an embodiment of the inventive arrangements disclosed herein. In diagram 200, desktop interface 210 can depict a state before the text exchange application has joined the interfaces. Desktop interface 250 can depict a state after the joining has been completed.

More specifically, desktop interface 210 can include the following interfaces; Cathy TE 220, Tom TE 222, Sam TE 224, Jill TE 226, and Sally TE 228. These interfaces 220-228 are each used for text exchange communication sessions involving a single communicator. The user of interface 210 can use a selectable tool 230 to select a set of these interfaces 220-228 and to join the set into a single interface. As shown, a lasso tool 230 can be used to select a point, then dragged out to enclose all the interfaces which should be joined. The joining tool 230 is not intended to be limited to a lasso, and any other selection mechanism can be used. For example, the interfaces 220-224 can be dragged and dropped into each other to effect the joining of the interfaces in another contemplated embodiment of the invention.

Once a set of interfaces to be joined is selected (230), a pop-up window 240 or other GUI element can permit a user to specify a group name 242. The merged interface 260 is referenced by this user-provided name 242. Interfaces not involved in a join operation, such as interfaces 226 and 228, remain unchanged in desktop 250, as shown by interfaces 266 and 268.

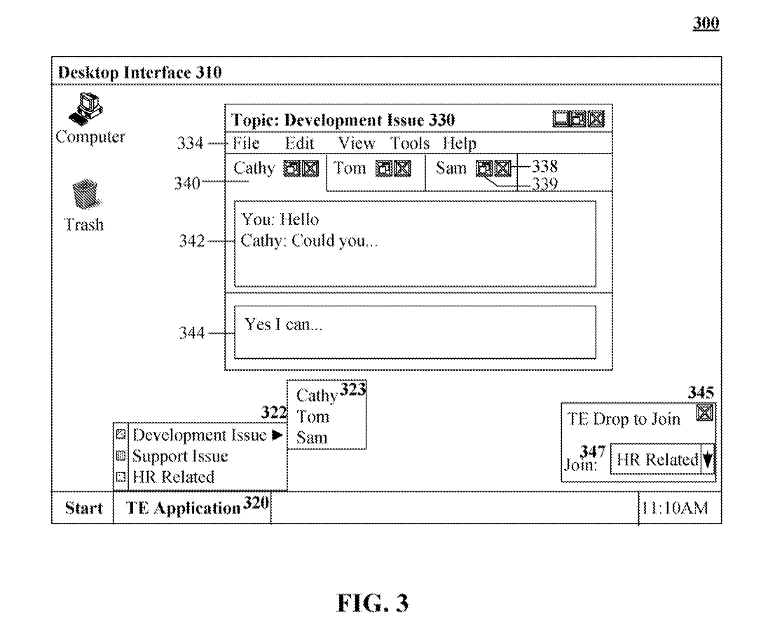

FIG. 3 shows an interface 300 which shows a desktop 310 including a combined text exchange interface 330. The combined interface 330 can include multiple tabs 340 for three different text exchange communication sessions—one for Cathy, one for Tom, and one for Sam. Each of these communication sessions could be initially established in a separate interface, which was joined together by a user selection of an interface join action.

A menu bar 334 can be included in the interface 330, which has numerous selectable options. The options can include, but are not limited to, an option for saving the conversation or conversations, for joining more text exchange communications, for splitting some of the text exchange communications back into separate text exchange communications, and the like.

Each communication session tab 340 can be used to show the current text exchange communications in the combined text exchange interface 330. In one embodiment, each tab can include an option to split 339 a communication session back into a separate interface and an option to close 338 or terminate the related communication session.

Communications for a session are presented in the exchange region 342. New messages can be input in the outgoing message 344 region.

Desktop taskbar entries 320 can be included for an executing text-exchange application. Selection of the base taskbar entry 320 can present a selectable pop-up, showing each topically or context based text exchange. Topically based interfaces can be expanded to show individual sessions 323. When a session is selected in a pop-up 322 or 323, it can be automatically displayed in the desktop 310. In one embodiment, when new communications are received for an interface, that interface can be visually designated.

For example, when new communications are received for an HR related interface, that interface can be highlighted in a characteristic color and/or be shown as a separate taskbar entry, which may blink or otherwise indicate new activity. In another embodiment, new communications for a session can result in a related tab 340 changing color to inform a user of an incoming message.

Desktop 310 can include a drop zone 345, into which users can drag and drop text exchange interfaces. Dropping an interface into the drop zone 345 results in the interface being added to an active combined interface 347, such as the HR related interface. When a combined interface, such as interface 330, is dragged and dropped into the drop zone 345, each component session can be added to the indicated interface 347.

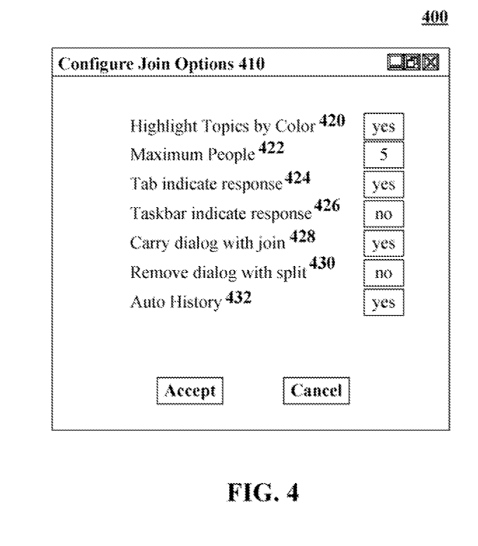

FIG. 4 shows an interface 400 that can be used to configure the behavior of joining multiple text exchange communications into a single topic based communication. The interface 400 can be used by a user 110 to configure behavior of the text exchange application 132 of system 100. The configurable options 420-432 represent a few contemplated user selectable settings and are not intended to be exhaustive.

Option 420 indicates whether topic based text exchange interfaces are to be color coded. Option 422 establishes a maximum number of people or communication sessions that can be combined into a single joined interface. A response indication option 424 can give the user the option to cause a GUI indicator to appear on the tab of a text exchange communication when a response is received. A taskbar response indication option 426 can give the user the option to cause a GUI indicator to appear on the taskbar to indicate a response has been received from one of the text exchange communications in the single topic based communication. The carry dialog option 428 can selectively cause text contained in a pre-joined interface to be added (e.g., carried over) to the joined interface. The remove dialog with split option 430 can cause text exchanges from a split session to be removed from a topic based interface's history or archive. The auto history option 432 can give the user the option to automatically show/record the conversation history from previous conversations associated with a text exchange interface.

It should he appreciated that the GUI elements and arrangements expressed in FIGS. 2-4 are for illustrative purposes only and are not intended to be interpreted as a constraint upon the invention. That is, different implementations of the invention lend themselves to different interface mechanisms, to which software developers will adapt implementation specifics. These adaptations, which permit a user to join multiple text exchange interfaces into a single interface, are all within the scope of the present invention. For example, different GUI tools, such as toolbars, ribbons, hot-keys, and the like other than those illustrated, can be utilized to achieve approximately equivalent results as those described herein.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following; a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for combining text exchange interfaces for different sessions into a single interface comprising:
detecting a join interface event associated with a plurality of different interfaces, each of the different interfaces being associated with at least one text exchange session;
creating a combined interface through which a user is able to participate in each of the text exchange sessions originally associated with the different interfaces;
presenting the combined interface in a graphical user interface; and
automatically closing the different interfaces responsive to the presenting step.

2. The method of claim 1, further comprising:
receiving a user input which triggers the join interface event.

3. The method of claim 2, wherein the user input is a drag and drop action, wherein the plurality of different interfaces comprises two interfaces, wherein a first one of the two interfaces is dragged and dropped into a second one of the two interfaces.

4. The method of claim 1, further comprising:
establishing a text exchange archive which stores text communications for each of the text exchange sessions handled by the combined interface.

5. The method of claim 1, wherein the creating, presenting, and closing steps occur transparent to remote communicators participating in any of the text exchange sessions associated with the combined interface.

6. The method of claim 1, wherein the combined interface comprises a plurality of user selectable tabs, each tab corresponding to one of the text exchange sessions.

7. The method of claim 1, further comprising:
receiving user input that designates a name for the combined interface; and
presenting the combined interface labeled with the designated name, wherein the designated name is a searchable parameter for communication logs associated with communications involving the combined interface.

8. The method of claim 1, further comprising:
receiving an incoming communication associated with one of the text exchange sessions; and
visually indicating an existence of the incoming communication within the graphical user interface.

9. The method of claim 1, wherein said steps of claim 1 are steps performed automatically by at least one machine in accordance with at least one computer program having a plurality of code sections that are executable by the at least one machine, said at least one computer program being stored in a machine readable medium.

10. A text exchange application comprising:
a joining engine configured to create a single combined text exchange interface from a plurality of user selected interfaces that are each associated with a text exchange session, wherein the combined text exchange interface is one enabling a user to participate in each of the text exchange sessions associated with the plurality of user selected interfaces.

11. The application of claim 10, wherein the joining engine comprises a set of programmatic instructions executable by a machine, said set being stored in a machine readable medium.

12. The application of claim 11, wherein the joining engine is a client-side program, and wherein the joining engine creates and utilizes the combined text exchange interface in a manner transparent to remote communicators participating in any of the text exchange sessions associated with the combined interface.

13. The application of claim 10, further comprising:
an archive data store configured to store and organize historical text exchange communications, wherein a combined archive object is maintained in the archive data store that corresponds to each combined text exchange interface, wherein the combined archive object is used to log communications associated with each communication session of the combined text exchange interface.

14. The application of claim 10, wherein the text exchange application is at least one of a chat application, a text messaging application, and an instant messaging application.

15. A combined text exchange interface comprising:
a plurality of user selectable graphical user interface items, each being associated with a text exchange communication session, wherein said text exchange interface includes a dialog region displaying text exchanged during the associated text exchange session and an outgoing region in which a user is able to type new messages that are to be conveyed to remote communicators involved in the associated text exchange session, wherein said combined text exchange interface is created responsive to a user selection from a plurality of different text exchange interfaces, wherein said plurality of different text exchange interfaces are used to conduct the text exchange communication sessions before the combined text exchange interface is created.

16. The combined text exchange interface of claim 15, wherein each of the graphical user interface items is a user selectable tab.

17. The combined text exchange interface of claim 15, further comprising:
a graphical indicator of an incoming communication from a remote communicator, wherein receipt of the incoming communication automatically triggers a presentation of the graphical indicator within the text exchange interface, wherein the graphical indicator indicates which of a plurality of communication sessions the incoming communication relates to.

18. The combined text exchange interface of claim 15, further comprising:
a context entry graphical item configured to permit a user to specify a topic for the combined text exchange interface, wherein the topic can be used to retrieve logs for any of the text exchange sessions associated with the combined text exchange interface.

19. The combined text exchange interface of claim 15, wherein the text exchange communication sessions comprise at least one of a text messaging communication session, an instant messaging communication session, and a chat communication session.

20. The combined text exchange interface of claim 15, wherein the text exchange communication sessions comprise at least two different types of communication sessions, said types of communication sessions comprising a text messaging communication session, an instant messaging communication session, and a chat communication session.
